(19) United States
(12) Patent Application Publication
(10) Pub. No.: US 2026/0291832 A1
(43) Pub. Date: Sep. 24, 2026

(54) RULES BASED CLASSIFICATION AND DYNAMIC NAMING SERVICE

(71) Applicant: Dell Products L.P., Round Rock, TX (US)

(72) Inventors: Jeyaprakash Sethuram, Singapore (SG); Nyi Nyi Thwin, Singapore (SG); Antony Prabakaran Jayaveeran, Singapore (SG)

(21) Appl. No.: 19/083,654

(22) Filed: Mar. 19, 2025

(51) Int. Cl. H04L 41/5041; G06F 16/38; G06F 40/186

(52) U.S. Cl. CPC H04L 41/5048; G06F 16/38; G06F 40/186

(57) ABSTRACT

A method for naming an information technology (IT) asset in a system includes creating rules and variables based on inputs from a user. Moreover, the method includes validating the variables and rules to obtain validate variables and validated rules. Further, the method includes creating a template based on the validated rules and the validated variables based on an input from a user and categorizing the template. The method further includes discovering the IT asset to have a name change and obtaining metadata from the IT asset describing the IT asset. Additionally, the method includes making a determination that the template is a correct template based on the metadata and mapping the metadata to the validated variables associated with the correct template. Finally, the method includes creating a name based on values from the mapped metadata to each variable in the correct template and implementing the name for the IT asset.

### BACKGROUND

Large information technology (IT) infrastructures may contain hundreds to thousands of IT assets. To properly track all of these IT assets, naming conventions must be created and implemented on the IT assets. Manual re-naming of IT assets can be cumbersome and time consuming due to the large amount of IT assets. Further, human intervention or validation is needed to ensure the naming conventions are correctly applied to the IT infrastructure.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system in accordance with one or more embodiments disclosed herein.

FIG. 1.2 shows a diagram of a dynamic naming service in accordance with one or more embodiments disclosed herein.

FIG. 1.3 shows a diagram of other services of a system in accordance with one or more embodiments disclosed herein.

FIG. 1.4 shows a table of example rules of a system in accordance with one or more embodiments disclosed herein.

FIG. 1.5 shows a table of example variables of a system in accordance with one or more embodiments disclosed herein.

FIG. 1.6 shows a table of example templates of a system in accordance with one or more embodiments disclosed herein.

FIG. 2 shows a flowchart for a method for creating templates in accordance one or more embodiments disclosed herein.

FIG. 3 shows a flowchart for a method for changing names of information technology (IT) assets in accordance one or more embodiments disclosed herein.

FIG. 4 shows a diagram of a computing device in accordance with one or more embodiments disclosed herein.

### DETAILED DESCRIPTION

Traditional naming of IT assets requires manual implementation of names. Techniques include, by default, products being named based on unique identifiers such as globally unique identifiers, service tags, and serial numbers. Users then manually change these names using their own naming conventions and classifications based on their needs. However, manually re-naming products may be challenging when the user operates hundreds to thousands of IT assets containing a plurality of devices, virtual machines, clusters, applications, etc. Moreover, human intervention or validation is needed to ensure the naming standards are met which may lead to human error causing business risk or customer impact. For at least the reasons discussed above, a different approach for naming IT assets may be beneficial.

Embodiments disclosed herein relate to a method to assign unique, user-friendly and identifiable names to any software configuration ecosystem (e.g., IT assets) such as devices, virtual machines, clusters, or applications. The names may be based on the products, regions the products are used, models of the products, the types of devices used for the products, and other defined parameters.

The naming service allows for efficient management of large amounts of products by the user. Based on user need or domain, the user can create naming rules and templates with multiple fields and labels as per their standard which can be customized and replaceable. If in the future renaming is required with different standards or format, the template can be reformatted to restructure all the data which will auto reflect the names in the IT assets. By allowing customizable, seamless and automated classification of hardware and configurable items, the method improves user operation. The flexibility that comes with the method also allows users to be adaptable to changes. This method streamlines the classification and naming process for vast networks of connected devices. By leveraging a dynamic rules-based engine, the method empowers users to define customizable parameters and variables that automate the organization of hundreds or thousands of endpoints, minimizing manual errors, maximizing operational efficiency, and freeing up resources. Templates and rules may be crafted to align with any unique business requirements, industry regulations, and brand standards. The method allows having one single consolidated service and rule repository to handle all the naming conversation needed not only by the user but also for the other services and resources under the same orchestrator.

The following describes various embodiments disclosed herein.

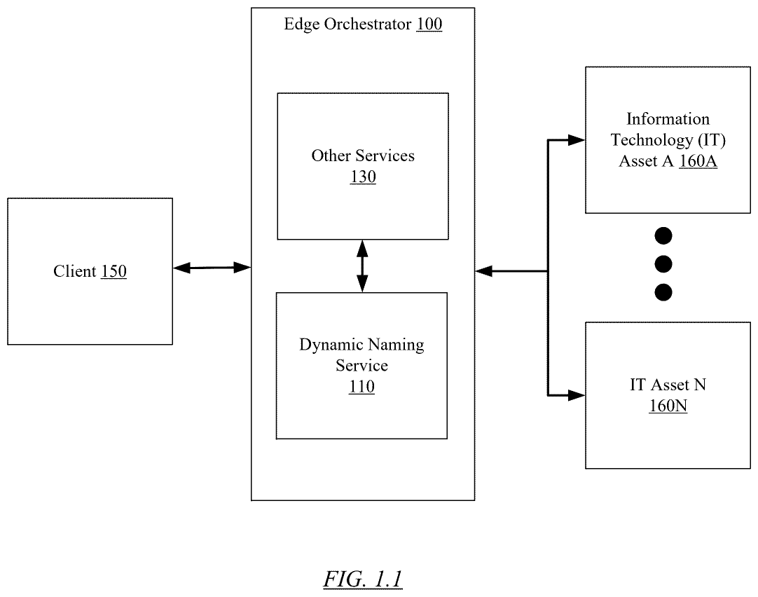

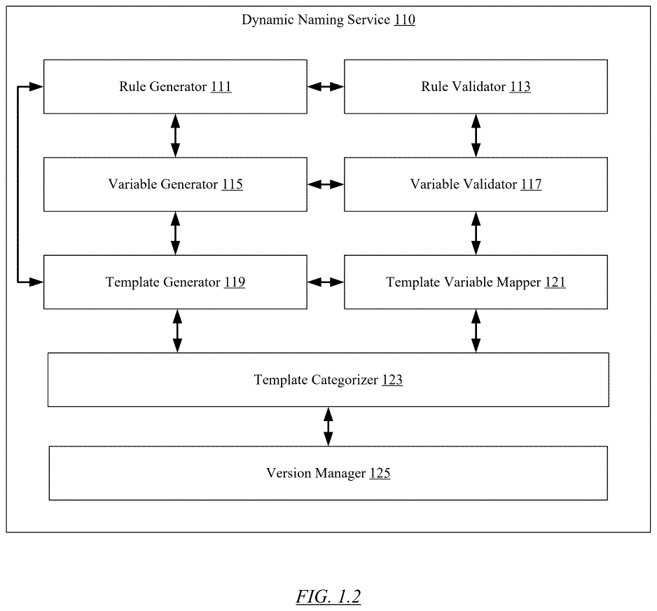

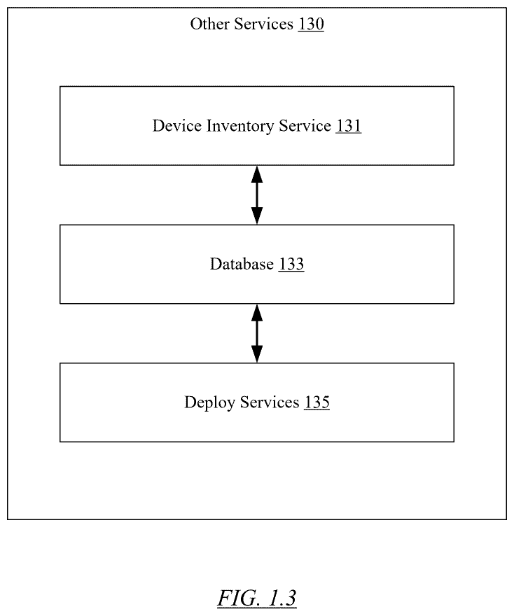

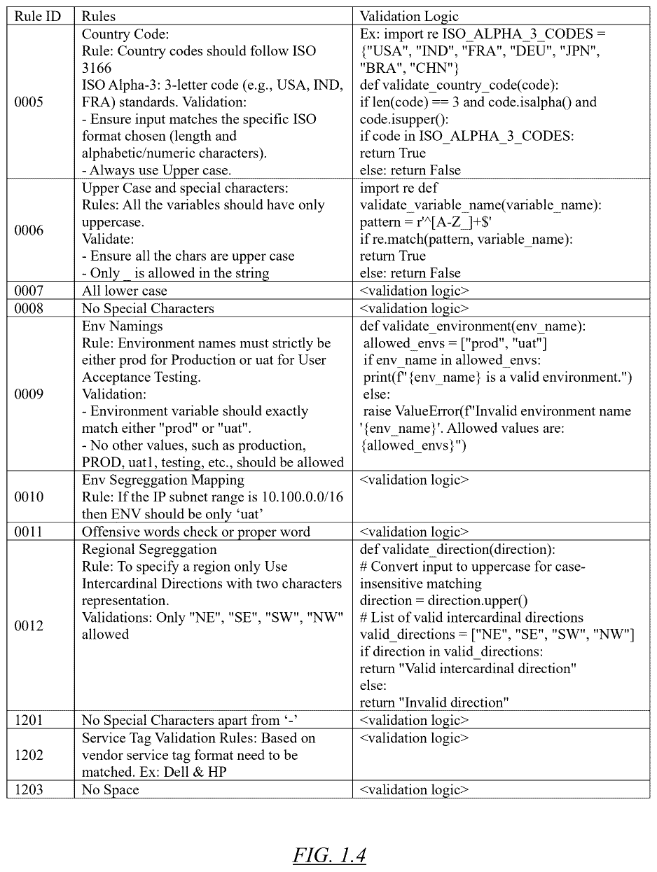

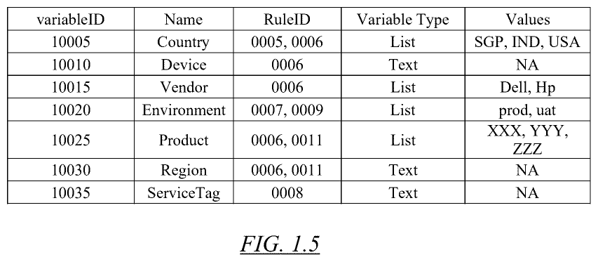

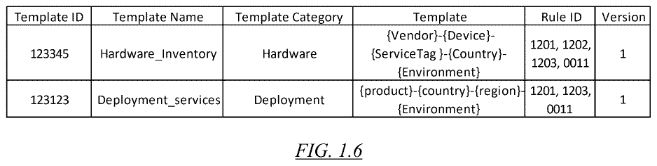

FIG. 1.1 shows a diagram of a system in accordance with one or more embodiments disclosed herein. The system includes an edge orchestrator (100), a client (150), and a plurality of IT assets (160A, 160N). Each of these components shown in FIG. 1.1 is described below.

The system may include additional, fewer, and/or different components without departing from the scope of the embodiments disclosed herein. Each component may be operably/operatively connected to any of the other components via any combination of wired and/or wireless connections (including connections to local area networks, wireless networks, and wide area networks). For example, the components shown in FIG. 1.1 may be connected via a network fabric (not shown). A network fabric refers to the interconnected topology and structure of network elements, e.g., switches, routers, and links, which work together to provide data transmission within between the components. The network fabric may be implemented using a spine-leaf topology, where every leaf switch connects to each spine switch. Those skilled in the art will appreciate that any other type of network (or network topology) may be used without departing from the disclosure.

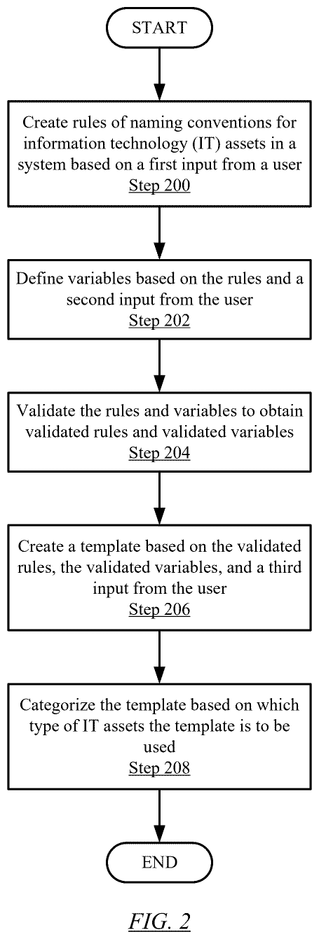

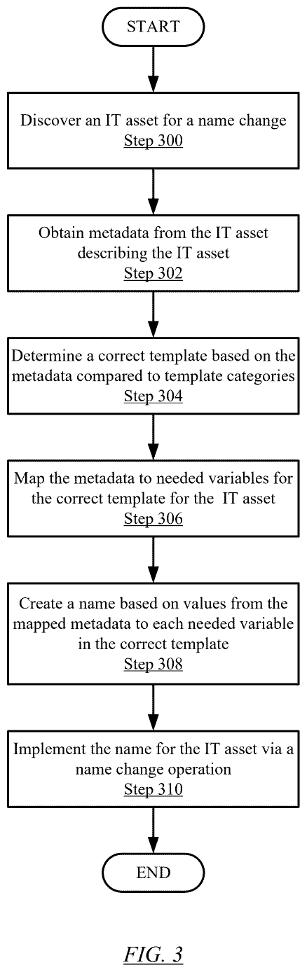

The edge orchestrator (100) includes a dynamic naming service (110) and other services (130). The edge orchestrator (100) is operatively connected to the client (150) to receive user inputs. The edge orchestrator (100) is also operatively connected to the plurality of IT assets (160A, 160N) to retrieve metadata from the plurality of IT assets (160A, 160N) and to affect name changes on to the plurality of IT assets (160A, 160N). The edge orchestrator (100) includes functionality to create naming templates and change the names of IT assets as shown in FIGS. 2-3.

The dynamic naming service (110) includes functionality to create naming templates and to create names with the templates using metadata from the plurality of IT assets (160A, 160N). The dynamic naming service (110) is operatively connected to the client (150). The dynamic naming service (110) is further described in FIG. 1.2. The other services (130) include functionality to obtain and determine metadata from the plurality of IT assets (160A, 160N), to store current and previous names of the plurality of IT assets (160A, 160N), and to effect name changes to the plurality of IT assets (160A, 160N). The other services (130) are operatively connected to the plurality of IT assets (160A, 160N) and the dynamic naming service (110). The other services (130) are further described in FIG. 1.3.

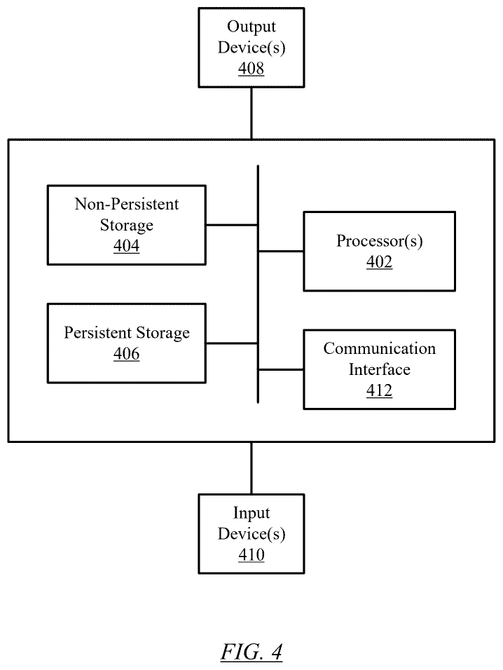

In one or more embodiments, the edge orchestrator (100) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the edge orchestrator (100) described throughout this application and/or all, or a portion thereof, of the method illustrated in FIGS. 2-3.

In one or more embodiments, the edge orchestrator (100) may be implemented as a logical device(s) (e.g., a virtual machine). Each logical device may utilize the computing resources of any number of computing devices and thereby provide the functionality of the edge orchestrator (100) described throughout this application and/or all, or a portion thereof, of the method illustrated in FIGS. 2-3.

In one or more embodiments, the client (150) is an interface for the user of the edge orchestrator (100) to create naming templates and initiate name changes for the plurality of IT assets (160A, 160N). The client (150) allows the user to provide inputs for variables, rules, and templates in the edge orchestrator (100) via a graphical user interface (GUI). The client (150) is interfaced to the dynamic naming service in a way such that allows for both web service communication and application programming interface communication. The client (150) includes functionality to initiate a name change in the plurality of IT assets (160A, 160N).

In one or more embodiments, the client (150) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the client (150) described throughout this application and/or all, or a portion thereof, of the method illustrated in FIGS. 2-3.

In one or more embodiments, the client (150) may be implemented as a logical device(s) (e.g., a virtual machine). Each logical device may utilize the computing resources of any number of computing devices and thereby provide the functionality of the client (150) described throughout this application and/or all, or a portion thereof, of the method illustrated in FIGS. 2-3.

In one or more embodiments, the plurality of IT assets (160A, 160N) may include an IT asset A (160A), an IT asset (160N), and any other number of IT assets. Each IT asset includes metadata that describes the device and is capturable by the edge orchestrator (100) to re-name the IT asset. plurality of IT assets (160A, 160N) may include devices (e.g., servers, computers, laptops, etc.), virtual machines, applications, etc.

In one or more embodiments, a portion of the plurality of IT assets (160A, 160N) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the plurality of IT assets (160A, 160N) described throughout this application and/or all, or a portion thereof, of the method illustrated in FIGS. 2-3.

In one or more embodiments, a portion of the plurality of IT assets (160A, 160N) may be implemented as a logical device(s) (e.g., a virtual machine). Each logical device may utilize the computing resources of any number of computing devices and thereby provide the functionality of the plurality of IT assets (160A, 160N) described throughout this application and/or all, or a portion thereof, of the method illustrated in FIGS. 2-3.

In one or more embodiments, a portion of the plurality of IT assets (160A, 160N) may be implemented as applications executing on a computing device(s) or a logical device(s). The application may provide the functionality of the plurality of IT assets (160A, 160N) described throughout this application and/or all, or a portion thereof, of the method illustrated in FIGS. 2-3.

Turning to FIG. 1.2, FIG. 1.2 shows a diagram of the dynamic naming service (110) in accordance with one or more embodiments disclosed herein. The dynamic naming service (110) includes a rule generator (111), a rule validator (113), a variable generator (115), a variable validator (117), a template generator (119), a template variable mapper (121), a template categorizer (123), and a version manager (125).

The rule generator (111) includes functionality to generate rules to govern variables and templates. The rules generator (111) is an interface with the client (150) which creates the rules. The rule generator (111) receives the inputs from the user to form the rules via the GUI of the client (150). The rules are further described in FIG. 1.4. The rule generator (111) may allow the user to change an existing rule. The rule validator (113) includes functionality to validate the rules generated by the rules generator (111) with validation logic. In one or more embodiments, the rule validator (113) includes a context-aware large language model (LLM) rule validation logic generator to generate validation logic with the rules as an input. The context-aware LLM is a machine learning model that allows the user to define the rules in simple terms that are converted during validation to a validation logic that can be used with the variables and templates. The validation logic is further described in FIG. 1.4.

The variable generator (115) includes functionality to generate variables to be used in the templates. The variable generator (115) is an interface with the client (150) which creates the variables. The variable generator (115) receives the inputs from the user to form the variables via the GUI of the client (150). The variables are further described in FIG. 1.5. The variable generator (115) may allow the user to change an existing variable. The variable validator (117) includes functionality to validate the variables with respect to the rules. Validating the variables is further described in FIG. 1.5.

The template generator (119) includes functionality to generate templates for naming IT assets. The template generator (119) receives the inputs from the user to form the templates via the GUI of the client (150). The template generator (119) is an interface with the client (150) which defines the template with validated variables and validated rules. In one or more embodiments, the template generator may suggest variables to the user to use in the template. Templates are further described in FIG. 1.6. The template generator (119) may allow the user to change an existing template.

The template variable mapper (121) is an interface between the other services (130) of the edge orchestrator (100) and the dynamic naming service (110) to dynamically map values to the variables in the template. In one or more embodiments, the template variable mapper (121) maps the values in real time. The other services (130) will provide metadata from the plurality of IT assets to the template variable mapper (121). The template variable mapper (121) includes functionality to extract required values from the metadata to satisfy the variables in the template. The required values may be used by the template variable mapper (121) to create names from the templates. The template variable mapper (121) communicates with the template categorizer (123) as described below. The template variable mapper (121) forms the names using the values and the template. The template variable mapper (121) includes functionality to transmit the names for the plurality of IT assets to the other services. In one or more embodiments, the template variable mapper (121) may prompt the user to update the name of an IT asset due to a change in the template, variable, rule, or metadata from the IT asset. In one or more embodiments, the change in the template, variable, rule, or metadata from the IT asset will automatically cause a change to the name of the IT asset.

The template categorizer (123) includes functionality to categorize templates based on which type of IT asset the template corresponds. The template categorizer (123) may differentiate between different types of templates for the same services and differentiate between different types of services. For example, different types of hardware used in the same services may be categorized differently, a hardware switch, a hardware device, a hardware inventory, etc. These different categories use different variables in the template. Template categories are further discussed in FIG. 1.6. The template categorizer (123) further includes functionality to determine the correct template category to use for the IT asset based on the metadata of the IT asset in conjunction with the template variable mapper (121).

The version manager (125) includes functionality to create a version history of each template, updating the version history every time the template is updated. This allows for the user to rollback to a previous version of the template. The version manager (125) includes an interface with the client (150) to provide a visualization of the version histories to the user via the GUI of the client (150). The version manager (125) also includes functionality to analyze the impact of updating the templates, providing users with how many of the plurality of IT assets will be affected by a change in a particular template. The version history is further described in FIG. 1.6.

In one or more embodiments, the dynamic naming service (110) is not limited to user action and IT assets. Any other services in the edge orchestrator (100) which require naming or categorization can interact with the API of the dynamic naming service (110) and make use of rules and templates.

Turning to FIG. 1.3, FIG. 1.3 shows a diagram of the other services (130) of the edge orchestrator (100) in accordance with one or more embodiments disclosed herein. The other services (130) include a device inventory service (131), a database (133), and deploy services (135).

The device inventory service (131) includes functionality to interface with the plurality of IT assets (160A, 160N). The device inventory service (131) collects metadata from an IT asset to be used to fill in variables to make names from the template for the IT asset. In one or more embodiments, the device inventory service (131) creates metadata to describe the IT asset by analyzing the IT asset. For example, the device inventory service (131) interfaces with a server. The device inventory service (131) then determines that the server is a fourth shelf on a third rack of a northeast data center located in the United States. The server vendor is company A and has a service tag of A3276. The device inventory service (131) passes this metadata to the template variable mapper (121) to be used to satisfy variables in the template and create a name for the server. In one or more embodiments, the device inventory service (131) is routinely or constantly checking for a change in the metadata of the IT assets. A change in the metadata of an IT asset will be transmitted to the template variable mapper (121) immediately when discovered.

The database (133) is configured to store the current names and previous names of the plurality of IT assets (160A, 160N) and to store the current versions and previous versions of the templates. The database (133) may also store the variables and rules of the dynamic naming service (110). The user may view these stored names, rules, variables, and templates using the GUI of the client (150). The database (133) also includes functionality to store the names after being created by the dynamic naming service (110).

The deploy services (135) includes the functionality to perform a name change operation on the plurality of IT assets (160A, 160N). The deploy services are operatively connected to the plurality of IT assets (160A, 160N) and retrieve the names from the database (133) to implement in the plurality of IT assets (160A, 160N).

Turning to FIG. 1.4, FIG. 1.4 shows a table of example rules of a system in accordance with one or more embodiments disclosed herein. The table show eleven rules as examples. A person of ordinary skill in the art would recognize that these rules are examples and other rules are contemplated by the embodiments. The table includes a column for Rule IDs (identification). The Rule ID identifies the rules allowing for the variables and the templates to identify the rules that apply. The rule IDs are short numerical codes that distinguish a rule from the other rules (e.g., 0005, 1201, etc.). The table further includes a column for the rules. The rules are formed from inputs from the user. The rules may be entirely inputted from the user. In one of more embodiments, the rules generator (111) may suggest rules for the user to implement. For example, as shown in FIG. 1.4, the rule country code includes that the country code should conform with International Organization for Standardization 3166, and alpha-3 standards and that the country code includes always upper-case letters. In another example, the rule offensive word search includes that offensive words and proper words should not be included in a variable or a template. Further examples are included in FIG. 1.4.

Finally, the table includes a column for validation logic. The validation logic is the code used by the variable validator (117) and the template generator (119) to determine if the variables and templates conform with the rules. The validation logic may be inputted by the user. In one or more embodiments, the LLM creates the validation logic with the rule as an input. The user may select a prompt (e.g., the rule) to generate the validation logic. After the validation logic is created, the validation logic is tested by the rule validator (113). Examples of validation logic are included in FIG. 1.4. Some validation logic for examples has been excluded for length concerns. In one or more embodiments, a similar table is available on the GUI of the client (150) to allow the user to see the active rules.

Turning to FIG. 1.5, FIG. 1.5 shows a table of example variables of a system in accordance with one or more embodiments disclosed herein. The table show seven variables as examples. A person of ordinary skill in the art would recognize that these variables are examples and other variables are contemplated by the embodiments. The table includes a column for variable IDs. The variable ID identifies the variable allowing the user and dynamic naming service (110) to identify the variables. The variable IDs are short numerical codes that distinguish a variable from the other variables (e.g., 10005, 10035, etc.). The table further includes a column for the variables. The variables are formed from inputs from the user. The variables may be entirely inputted from the user. In one of more embodiments, the variable generator (115) may suggest variables for the user to implement. For example, as shown in FIG. 1.5, the variable country is a variable that depends on the country where the IT asset is located. In another example, the variable environment depends on what environment the IT asset is located. Further examples of variables are included in FIG. 1.5.

The table also includes a column for rule IDs. The rule IDs indicate which rules apply to the variable. To be validated, the variable must be in compliance with the rule IDs indicated. Finally, the table includes a column for variable type and a column for values. Two types of variables exist: list and text. List variables contain a set of values that satisfy the variable in the value section. Text variables do not contain a set of values that satisfy the variable, and the value section is filled with n/a. For example, the country variable is a list variable. The number of countries the IT asset could be located is a small enough set that all are included in the value section (e.g., SGP, USA, IND, etc.). However, the environment variable may contain very many possible values and does not have the values listed and is therefore a text variable. For a list variable, the template variable mapper (121) extracts one of the listed values from the metadata. For a text variable, the template variable mapper (121) extracts a value that complies with the rules and satisfies the variable. Further examples of values are included in FIG. 1.5. In one or more embodiments, a similar table is available on the GUI of the client (150) to allow the user to see the active variables.

Turning to FIG. 1.6, FIG. 1.6 shows a table of example templates of a system in accordance with one or more embodiments disclosed herein. The table show two templates as examples. A person of ordinary skill in the art would recognize that these variables are examples and other variables are contemplated by the embodiments. The table includes a column for template IDs. The template ID identifies the template allowing the user and dynamic naming service (110) to identify the template. The template IDs are short numerical codes that distinguish a template from the other templates (e.g., 123123, 123345, etc.). The table further includes a column for template names and a column for template categories. The template name describes what the group of IT assets which the template is to be used. The template categories help to map the different types of services within multiple different template types. In one or more embodiments, the template name includes the template category with additional detail (e.g., template name: hardware_inventory, template category: hardware).

The table also includes a column for the template. The template is a string of variables in a determined order with each variable separated by a special character (e.g., a dash). The template is to be used to name all IT assets in the template category determined by the dynamic naming service (110) to belong to that template name. For example, the template hardware_inventory layout is {vendor}-{device}-{servicetag}-{country}-{environment} and the deployment_services layout is {product}-{country}-{region}-{environment}). The table includes a column for rule IDs. The rule IDs indicate which rules apply to the template. To be validated, the template must be in compliance with the rule IDs indicated. Finally, the table includes a column for the versions. The versions indicate if there are previous versions of the template in the version history. Previous versions may allow the user to roll back to a previous version of the template. In one or more embodiments, a similar table is available on the GUI of the client (150) to allow the user to see the active templates.

Turning to FIG. 2, for a method for creating templates in accordance one or more embodiments disclosed herein. The method of FIG. 2 may be performed by, for example, the dynamic naming service (e.g., 110, FIG. 1.1) and the other services (e.g., 130, FIG. 1.1. Other components of the system of FIG. 1.1-1.3 may perform all, or a portion, of the method of FIG. 2 without departing from the disclosure.

While the various steps in the flowchart of FIG. 2-3 are presented and described sequentially, one of ordinary skill in the relevant art will appreciate that some or all of the steps may be executed in different orders, may be combined, or omitted, and some or all steps may be executed in parallel.

In Step 200, the dynamic naming service creates rules of naming conventions for a plurality of IT assets in the system based on a first input from a user. The first input may be inputted into the dynamic naming service on a GUI of a client (e.g., 150, FIG. 1.1). Once the rules are created, the rules need validation logic. The validation logic is how the rules are enforced (e.g., verified to be in compliance). In one or more embodiments, a LLM generates the validation logic with the rules as an input. In one or more embodiments, the user inputs the validation logic. After being created the validation logic is tested using input parameters to confirm the validation logics effectiveness. For example, the user communicates the creation of nine rules, five directed to variables and four directed to templates. The five variable rules include country code format, all uppercase letters and no special characters, all lower-case letters, and no special characters. The user selects the LLM to generate the validation logic which is verified to work.

In Step 202, the dynamic naming service defines variables based on the rules and a second input from the user. The variables may be satisfied by values from sets of values. Each of the variables contain a group of rules that define the variables. In one or more embodiments, the user inputs the rules that apply to a variable in the second input. Some variables with a limited number of values that satisfy the variable are list variables. The second input may contain a list of values for the list variables. Some variables may be satisfied with a large number of values and are text variables. The values that satisfy the list variables are retrieved from the IT asset to be named. The values will also comply with the rules assigned to the variable. The second input may be inputted into the dynamic naming service on the GUI of the client. Once the variables and rules are created, the rules and variables need to be verified. For example, the user communicates the creation of five variables. The five variables include vendor, device, servicetag, country, and location. The variable country is to comply with the rules country code format, all upper case letters, and no special characters. The variable country is a list variable and includes the three countries where the user operates: the United States (USA), India (IND), and Singapore (SGP).

In Step 204, the dynamic naming service validates the rules and variables to obtain validated rules and validated variables. The variables are validated by executing the variables and the rules as defined. If a variable is consistent with the rules, the variable is a validated variable, if not an error message indicates the variable needs to be modified. If a rule is consistent with the criteria of the rule, the rule is a validated rule, if not an error message indicates that the rule needs to be modified. For example, the dynamic naming service validates the rules to be consistent with the criteria and the variables to be consistent with the applicable rules. After validation, the user may then create a template.

In Step 206, the dynamic naming service creates a template based on the validated rules, the validated variables, and a third input from the user. The template includes selected validated variables conforming to the validated rules in a specific order (e.g., variables and strings as a suffix). Each of the templates contain a group of rules that define the template. In one or more embodiments, the user inputs the rules that apply to a variable in the second input. The third input may be inputted into the dynamic naming service on the GUI of the client. The template includes a version so a version history of each template may be tracked. For example, the user may use the rules and variables to create a template. The template is named hardware_inventory and includes the layout {vendor}-{device}-{servicetag}-{country}-{location}. The template is to comply with the rules no offensive words, no special characters besides “-”, and no spaces.

In Step 208, the dynamic naming service categorizes the template based on which type of IT asset the template is to be used. The template is placed into one of several categories as described in FIG. 1.2 and 1.6. The same category can refer between different services to call other services endpoints or configurable items of IT assets. The categories help with selecting the correct template for a particular IT asset as shown in FIG. 3. For example, the template hardware_inventory is categorized as hardware to be used with hardware IT assets. The template hardware_inventory is then stored for later use.

After Step 208, the method may end.

Turning to FIG. 3, FIG. 3 shows a flowchart for a method for changing names of information technology (IT) assets in accordance one or more embodiments disclosed herein. The method of FIG. 3 may be performed by, for example, the dynamic naming service (e.g., 110, FIG. 1.1) and the other services (e.g., 130, FIG. 1.1). Other components of the system of FIG. 1.1-1.3 may perform all, or a portion, of the method of FIG. 3 without departing from the disclosure.

In Step 300, a device inventory service (e.g., 131, FIG. 1.3) of the other services discovers an IT asset needing a name change. In one or more embodiments, a user initiates a name change via a client (e.g., 150, FIG. 1.1) connected to the device inventory service. In one or more embodiments, the device inventory service detects the dynamic naming service has modified a template, variable, or rule causing a need for a name change. In one or more embodiments, the device inventory service detects a change in the metadata of the IT asset or that the IT asset has an initial name not suitable causing a need for a name change. For example, a server is installed in a data room of the user with an initial manufacturer provided name. The device inventory service is programmed to initiate a name change from the initial manufacturer provided name to a user-compliant name.

In Step 302, the device inventory service obtains metadata from the IT asset describing the IT asset. The device inventory service is connected to the IT asset. In one or more embodiments, the device inventory service retrieves the metadata stored on the IT asset. In one or more embodiments, the device inventory service creates the metadata based on analyzing the IT asset. In one or more embodiments, the device inventory service does a combination of retrieving and creating metadata on the IT asset. For example, the device inventory service obtains metadata from the IT asset. The metadata includes that the IT asset is a server in a data room in the United States on a fifth position on a first rack in a first row. The IT asset is made by company A and has service tag of A1960Z.

In Step 304, the dynamic naming service determines a correct template based on the metadata compared to template categories. In one or more embodiments, the correct template is the template created in the method of FIG. 2. The metadata is transmitted to a template variable mapper (e.g., 121, FIG. 1.2) of the dynamic naming service. The template variable mapper communicates the metadata to the template categorizer (e.g., 123, FIG. 1.2). The template categorizer determines which template category the IT asset would be contained in by analyzing the metadata. Once the template category is selected, the template variable mapper determines the correct template in the template category based on the metadata. In one or more embodiments, the dynamic naming service may consider if the previous template used for the name of the IT asset, still exists and still applies to the IT asset. For example, the dynamic naming service analyzes the metadata collected in Step 302 and determines that the IT asset should use a template categorized as hardware. The dynamic naming service further determines that the template hardware_inventory should be used.

In Step 306, the dynamic naming service maps the metadata to needed variables for the correct template for the IT asset. The variables associated with the correct template are mapped to the metadata of the IT asset by the template variable mapper. The template variable mapper determines that all variables of the correct template may be satisfied based on the rules of the template and the variables. If all the variables cannot be satisfied, a new correct template is selected, or an error message is sent to the user. For example, the dynamic naming service maps the country location of the data room, the United States, to the country variable. The other pieces of metadata are mapped to the correct variables.

In Step 308, the dynamic naming service creates a name based on values from the mapped metadata to each needed variable in the correct template. The mapped metadata is used to create values to satisfy the variables in the correct template. For any list variables, the dynamic naming service determines from the metadata which of the list of values satisfies the list variable. For text variables, the dynamic naming service determines a correct value from the metadata that satisfies the text variable. For example, because the country variable is a list variable, the dynamic naming service selects the value USA to describe the United States. The other mapped metadata values are formatted to conform with the rules of the variables and the template. For example, the dynamic naming service creates the name based on the mapped metadata. The name reads COMPANYA-SERVER-A1960Z-USA-row1rack1position5.

In Step 310, deploy services (e.g., 135, FIG. 1.3) of the other services implement the name for the IT asset via a name change operation. The name change operation includes the new name being stored in a database (e.g., 130, FIG. 1.3). The deploy services retrieves the name from the database and supplants the previous name on the IT asset with the name. In one or more embodiments, the deploy services, connected to the IT asset and the database, searches the database for the name by looking for the previous name identified from the IT asset which is stored with the name in the database. Once the deploy services identifies the name using the previous name, the name change is implemented. In one or more embodiments, the deploy services knows the IT asset for the name change. The deploy services identifies the name of the IT asset in the database by matching the metadata of the IT asset retrieved to the metadata stored in the database. For example, the name created in Step 308 is stored in the database. The deploy services match the metadata used to create the name with the metadata of the IT asset and replaces the previous name with COMPANYA-SERVER-A1960Z-USA-row1rack1position5. After Step 310, the method may end.

Although shown as a name change of a single IT asset. The method above contemplates changing the name of a plurality of IT assets due to a new variable, new rule, new template, or change in the metadata of the IT assets at once.

As discussed above, embodiments of the disclosure may be implemented using computing devices. FIG. 4 shows a diagram of a computing device in accordance with one or more embodiments disclosed herein. The computing device may include one or more computer processor(s) (402), non-persistent storage (404) (e.g., volatile memory, such as RAM, cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the disclosure, the processor(s) (402) may be an integrated circuit for processing instructions. For example, the computer processor(s) may be one or more cores or micro-cores of a processor. The computing device may also include one or more input devices (410), such as a touchscreen, keyboard, mouse, microphone, touchpad, electronic pen, or any other type of input device. Further, the communication interface (412) may include an integrated circuit for connecting the computing device to a network (not shown) (e.g., a local area network (LAN), a wide area network (WAN) such as the Internet, mobile network, or any other type of network) and/or to another device, such as another computing device.

In one embodiment of the disclosure, the computing device may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to enable the computer processor to perform one or more embodiments described herein.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method for naming an information technology (IT) asset in a system, comprising:
creating, by a naming service, rules of naming conventions for a plurality of IT assets in the system, wherein the rules are based on a first input from a user;
defining, by the naming service, variables based on the rules, wherein at least one variable is satisfied by a value from a set of values that comply with the rules and the variables are based on a second input from the user;
validating the variables and the rules to obtain validated variables and validated rules;
creating, by the naming service, a template based on the validated rules and the validated variables, wherein the template comprises selected validated variables conforming to the validated rules and the template is based on a third input from a user;
categorizing the template based on which type of IT asset from the plurality of IT assets the template corresponds;
after categorizing the template:
discovering the IT asset to have a name change;
obtaining, after discovering the IT asset, metadata from the IT asset describing the IT asset;
making a first determination that the template is a correct template for the IT asset based on the metadata;
mapping, in response to the first determination, the metadata to the selected validated variables associated with the correct template for the IT asset;
creating a name based on values from the mapped metadata to each needed variable in the correct template; and
implementing the name for the IT asset via a name change operation.

2. The method of claim 1, wherein variables comprise country variables, device variables, vendor variables, environment variables, product variables, region variables, and service tag variables.

3. The method of claim 2, wherein the country variables comprise a set of values comprising countries where the system is present.

4. The method of claim 1, wherein the template specifies an order of validated variables and applicable validated rules.

5. The method of claim 1, wherein the name change operation comprises:
storing the name in a database;
matching the name to the IT asset; and
replacing a previous name of the IT asset with the name.

6. The method of claim 1, wherein the first input by the user specifies the rules in simple terms which are validated by a large language model rule validation logic generator into rules usable for naming the plurality of IT assets.

7. The method of claim 1, wherein the plurality of IT assets comprises devices, virtual machines, clusters, and applications.

8. The method of claim 1, wherein the first input, the second input, and the third input of the user are communicated to the naming service via a web service.

9. A non-transitory computer readable medium (CRM) comprising computer readable program code, which when executed by a computer processor enables the computer processor to perform a method for naming an information technology (IT) asset in a system, the method comprising:
creating, by a naming service, rules of naming conventions for a plurality of IT assets in the system, wherein the rules are based on a first input from a user;
defining, by the naming service, variables based on the rules, wherein at least one variable is satisfied by a value from a set of values that comply with the rules and the variables are based on a second input from the user;
validating the variables and the rules to obtain validated variables and validated rules;
creating, by the naming service, a template based on the validated rules and the validated variables, wherein the template comprises selected validated variables conforming to the validated rules and the template is based on a third input from a user;
categorizing the template based on which type of IT asset from the plurality of IT assets the template corresponds;
after categorizing the template:
discovering the IT asset to have a name change;
obtaining, after discovering the IT asset, metadata from the IT asset describing the IT asset;
making a first determination that the template is a correct template for the IT asset based on the metadata;
mapping, in response to the first determination, the metadata to the selected validated variables associated with the correct template for the IT asset;
creating a name based on values from the mapped metadata to each needed variable in the correct template; and
implementing the name for the IT asset via a name change operation.

10. The non-transitory CRM of claim 9, wherein variables comprise country variables, device variables, vendor variables, environment variables, product variables, region variables, and service tag variables.

11. The non-transitory CRM of claim 10, wherein the country variables comprise a set of values comprising countries where the system is present.

12. The non-transitory CRM of claim 9, wherein the template specifies an order of validated variables and applicable validated rules.

13. The non-transitory CRM of claim 9, wherein the name change operation comprises:
storing the name in a database;
matching the name to the IT asset; and
replacing a previous name of the IT asset with the name.

14. The non-transitory CRM of claim 9, wherein the first input by the user specifies the rules in simple terms which are validated by a large language model rule validation logic generator into rules usable for naming the plurality of IT assets.

15. The non-transitory CRM of claim 9, wherein the plurality of IT assets comprises devices, virtual machines, clusters, and applications.

16. The non-transitory CRM of claim 9, wherein the first input, the second input, and the third input of the user are communicated to the naming service via a web service.

17. A system comprising:
a processor;
storage comprising instructions, which when executed by the processor perform a method, the method comprising:
creating, by a naming service, rules of naming conventions for a plurality of IT assets in the system, wherein the rules are based on a first input from a user;
defining, by the naming service, variables based on the rules, wherein at least one variable is satisfied by a value from a set of values that comply with the rules and the variables are based on a second input from the user;
validating the variables and the rules to obtain validated variables and validated rules;
creating, by the naming service, a template based on the validated rules and the validated variables, wherein the template comprises selected validated variables conforming to the validated rules and the template is based on a third input from a user;
categorizing the template based on which type of IT asset from the plurality of IT assets the template corresponds;
after categorizing the template:
discovering the IT asset to have a name change;
obtaining, after discovering the IT asset, metadata from the IT asset describing the IT asset;
making a first determination that the template is a correct template for the IT asset based on the metadata;
mapping, in response to the first determination, the metadata to the selected validated variables associated with the correct template for the IT asset;
creating a name based on values from the mapped metadata to each needed variable in the correct template; and
implementing the name for the IT asset via a name change operation.

18. The system of claim 17, wherein the name change operation comprises:
storing the name in a database;
matching the name to the IT asset; and
replacing a previous name of the IT asset with the name.

19. The system of claim 17, wherein the first input by the user specifies the rules in simple terms which are validated by a large language model rule validation logic generator into rules usable for naming the plurality of IT assets.

20. The system of claim 17, wherein the first input, the second input, and the third input of the user are communicated to the naming service via a web application.
